(19) United States
(12) Patent Application Publication
(10) Pub. No.: US 2013/0263171 A1
(43) Pub. Date: Oct. 3, 2013

(54) INTERNET AND OVER THE AIR TELEVISION SYSTEM

(71) Applicants: Alexander B. Calhoun, Orlando, FL (US); MARK A. GINTIS, Boca Raton, FL (US)

(72) Inventors: Alexander B. Calhoun, Orlando, FL (US); MARK A. GINTIS, Boca Raton, FL (US)

(21) Appl. No.: 13/433,257

(22) Filed: Mar. 28, 2012

(51) Int. Cl. H04N 21/25; H04N 21/60; H04N 21/482

(52) U.S. Cl. 725/25; 725/46; 725/110

(57) ABSTRACT

A portable, high definition home entertainment component integrates all of the most relevant media types together into one unit for home use. WhiteHatt™ combines such media as live television, built-in DVR (digital video recorder), Internet Television, Internet Radio, social networking, Blu-ray/DVD (digital video disc) w/ 3D, Media Center, and VoiP (voice over Internet protocol) among other media sources, into one, high quality consumer electronic device. WhiteHatt allows the user to eliminate the necessity of maintaining a monthly cable television (CATV) or satellite cable (SATV) subscription, removing the expense of the monthly cable bill, while increasing television content selection and overall viewing quality.

### FIELD OF THE INVENTION

The present invention relates generally to Internet television. The present invention is more particularly, a fully-featured, user-focused Internet television system that combines all the relevant media types, including DVD, Blu-ray, Media Center, Surround Sound, Internet TV, ATSC TV, Internet Radio, and VoIP, together into one integrated unit for home use.

### BACKGROUND OF THE INVENTION

Since 2004, the average cable bill has risen 59%, the largest portion of increase, nearly 35%, occurring since 2010. This trend is expected to continue and it has been reported that the recent Comcast/NBC merger will end up costing Comcast customers 2.4 billion dollars in increased monthly fees over the next nine years. Moreover, these fees are reflected in Comcast's new fee structure announced in August 2011, with the average Comcast customer paying an additional $20 per month in their next Cable bill. Customers outside of the Comcast network will continue to see an average annual price hike of 5% from their local provider. As a result, there has been a movement of consumers to end their cable subscriptions and switch to some variety of Internet-enabled television component. As the movement has grown, more than nine million subscribers have already terminated their wireline cable television (CATV) services and opted for an Internet-connected television device. As referred to herein, the term “wireline” shall be used to refer to terrestrially delivered cable television and Internet services. Analysts estimate that CATV will lose more than 45% of its subscribers to Internet Television (Web TV) over the next five years. Even with the companion components, such as cable and satellite TV add-on Internet TV devices, the user incurs either a monthly premium or viewing fees for each on-demand selection. These fees are paid in addition to customers' regular monthly CATV subscriptions.

Accordingly, a “companion box,” such as Apple TV, Google TV, Boxee, etc., is often considered a handy addition to the home entertainment environment. However, “companion boxes” do not provide the customers with any financial savings, because they still require the input from a CATV (or similar) subscription in order to deliver programming. Thus, despite the many marketing efforts made to sell companion boxes, companion boxes are not a suitable alternative to cable and will not enable a customer to end a CATV subscription and continue to enjoy the same media experience.

In light of the above, it would be advantageous to provide a fully featured all-in-one “cable TV Alternative,” enabling a viewer to enjoy the same television services provided by cable or satellite television, without any additional monthly fees required for the services. The WhiteHatt STB (Smart Top Box™), of the present invention provides customers with a fully featured all-in-one “cable TV alternative” including live programming, integral DVR (digital video recorder), Blu-ray/DVD (digital video disc) player, Internet Television, social networking, Internet Radio, and local programming without requiring a cable or satellite cable subscription or other viewing fees. Use of the present invention will result in substantial annual savings to WhiteHatt users while delivering the same programming to which the viewer is accustomed. These savings are estimated at approximately $3000, over three (3) years without sacrificing television content or viewing quality.

### SUMMARY OF THE INVENTION

The system contemplated by the present invention is known as WhiteHatt Internet Television (“WhiteHatt”). WhiteHatt is an all-in-one, portable, high definition home entertainment component that integrates all of the most relevant media types together into one unit for home use. WhiteHatt combines such media as live television, built-in DVR (digital video recorder), Internet Television, Internet Radio, social networking, Blu-ray/DVD (digital video disc) w/ 3D, Media Center, and VoIP (voice over Internet protocol) among other media sources, into one, high quality consumer electronic device. WhiteHatt allows the user to eliminate the necessity of maintaining a monthly cable television (CATV) or satellite cable (SATV) subscription, removing the expense of the monthly cable bill, while increasing television content selection and overall viewing quality.

The WhiteHatt Internet Television unit, physically, is a small, set box typically placed on or near a video display device, and referred herein as a Smart Top BOX™ (STB), that connects to a standard television or other viewing display via an HDMI (High-Definition Multimedia Interface) or similar cable. As used herein, a Smart Top Box is defined as a device, used in conjunction with a television or video display, which is implemented as a managed computer environment which has the simplicity of a set top box (typically used for television) that is implemented in a managed computer environment that is managed remotely over the IM channel. The system contemplated by the present invention includes the WhiteHatt player itself, the operating system, the user remote control tablet, and WhiteHatt smartphone applications (“apps”). Each of these subsections will be discussed in detail below.

WhiteHatt is designed as an entertainment system component, with multiple inputs and outputs to accommodate USB (universal serial bus), coaxial, HD (high-definition) video, HD audio, Ethernet, HDMI, Over-The-Air (OTA) Antennae, such as ASTC (Advanced Television Systems Committee) and DVB (Digital Video Broadcasting), and VoIP inputs, among others. The foregoing is a non-exhaustive list of possible inputs and outputs to the present invention. Notionally, the output is designed to be a single HDMI (or similar) connection to the television, monitor, or other display for simplicity. The multitude of inputs and outputs allows WhiteHatt to seamlessly integrate into an individual's existing entertainment system, media center, or even, though not required, with CATV or SATV systems.

Once connected to a monitor or other display, the only other functional requirements are a power supply and a high-speed wired or wireless (Wi-Fi) Internet connection. WhiteHatt is equipped with four digital television tuners enabling the STB to receive, display, and record four live broadcast channels simultaneously. WhiteHatt's built-in DVR, and hard drive capacity allow the user to record and store more than four hundred hours of 1080p HD programming, and may record all four channels at once. SATV, CATV, or specially designed OTA antennae may be employed to receive multiple aerially broadcast HO channels at once. Viewers receive all the major networks, NBC, ABC, CBS, CW, FOX, and ION in high definition, as well as many regional and local network programs, broadcast in high definition without any monthly charges or subscription fees, available via an aerial, HD OTA (ATSC, DVB, or similar) antenna. No wireline CATV or SATV services are required to use any of the features included in WhiteHatt, however CATV and SATV services are compatible with the WhiteHatt architecture.

Further, the STB has an integrated uninterruptible power supply (UPS) that will continue to provide stable power to the associated router and OTA antennae in the event of a brown out or power loss for five to seven minutes. This is particularly useful should the user be recording media with the DVR during the brown out or temporary power loss. The STB will not have sufficient power to continue powering other attached components, such as the attached display in this instance, however as long as the HD signal to the OTA antenna and/or the Internet connection remains active, recording will proceed uninterrupted, provided power returns to the customer premises prior to the exhaustion of the UPS's battery reserve. The user will receive a visual and/or audible alert via the remote tablet when the UPS's battery reserve is nearly exhausted, at which point the any recordings will be ceased, and the STB will execute a graceful shutdown, preserving recorded media. The UPS will further act as a voltage and power regulator for all connected components in the event of a power surge.

WhiteHatt is controlled remotely by the accompanying remote tablet, or via a smartphone app. These remote control options increase freedom and simplify the way customers enjoy their programming. The remote control tablet is a Wi-Fi connected, tablet design with controls for the various systems contained within WhiteHatt. The remote control has an integrated touchscreen LCD (liquid crystal display) that displays user-directed content such as advertisements, in addition to URLs (Universal Resource Locator) and commands to the WhiteHatt STB. The smartphone application is capable of controlling the WhiteHatt system to the same degree of capability as the remote tablet.

The WhiteHatt remote tablet's LCD displays content based on demographics and personal information contained within the WhiteHatt system itself. This information however, never leaves the STB. Users input their information at time of purchase, and/or upon addition of an additional user in the home. As users make content selections and viewing decisions, the WhiteHatt operating system continuously records and “learns” the viewing habits of the particular user, adaptively creating user-specific filters that are applied to incoming media. Media in the form of commercial advertisements and offers from vendors are broadcast to the WhiteHatt STB with no particular audience in mind. Selected media from the broadcast is then transmitted to the user, predicated on the filters, individual user settings, and viewing habits that are wholly contained within the Smart Top BOX™ and the remote control.

To safeguard personal information and protect privacy, the details of users' preferences never actually leave the STB. Media is broadcast to the STB and filtered locally. As the filters are fine-tuned by the WhiteHatt OS through continued use, increasingly specific advertising is transmitted to the user. As users access the links provided through this process, the click-through rates are recorded and provide a means for revenue generation by WhiteHatt Technologies, Inc. The user then receives that content on the WhiteHatt system's associated large format display, but his or her information remains safely stored behind a firewall within the OS, and may be backed up in encrypted form within the STB or in a remotely located operations center, unless he or she voluntarily decides to release that information.

The operating system (“OS”) adopted in the present invention is a custom Windows-based user interface (“UI”). The UI incorporates an architecture such as Microsoft “Windows Embedded Standard 7C (WES7C)” with a WhiteHatt Custom UI. The WhiteHatt OS has a Proprietary Parental Control application with content logging, parental notifications, and remote lock-out from the WhiteHatt remote tablet and/or WhiteHatt smartphone app. The OS has partitioned user accounts for expanded security, parental controls, and privacy. The OS further combines component controls for Blu-ray, DVD, Coaxial, ATSC TV for local programming, Internet Television, Bluetooth™, Wi-Fi and Microsoft Media Center. Content is encrypted upon its upload to WhiteHatt, thus, it cannot be distributed without a user's authorization. In addition, any attempts to distribute unlicensed content create on screen FBI warnings that lock the WhiteHatt unit until proper action is taken.

### BRIEF DESCRIPTION OF THE DRAWING

The objects, features, and advantages of the method according to the invention will be more clearly perceived from the following detailed description, when read in conjunction with the accompanying drawing, in which like reference numerals designate like parts throughout, and wherein:

FIG. 1 is an schematic block diagram of the WhiteHatt Internet Television system of the present invention, depicting the overall system architecture and interrelation of the Internet, Network Operations Center, Customer Service, and the various components of the system within the Customer Premises, including the remote control systems, as implemented by WhiteHatt hardware and software protocols;

FIG. 2 is a plan view of the top of the WhiteHatt Smart Top Box™ (STB) of the WhiteHatt Internet Television system of the present invention, depicting the recessed panel for the various connections for input to and output from the system, and location of the Blu-ray/DVD drive.

FIG. 3 is a perspective view of the bottom and back of the WhiteHatt STB of the WhiteHatt Internet Television system of the present invention, depicting a recessed access panel featuring a remote tracker button and various possible connections for input and output to the system, such as USB, coaxial cable, HD video or HD audio port, Ethernet, HDMI, and VoIP;

FIG. 4 is a plan view of the front of the WhiteHatt STB of the WhiteHatt Internet Television system of the present invention, depicting the Blu-Ray/DVD/CD slot, in addition to the placement of the Bluetooth™ and Wi-Fi antennae; and

FIG. 5 is a plan view of the top of the remote tablet of the WhiteHatt Internet TV system of the present invention, depicting fully programmable touchscreen liquid crystal display (LCD) allowing full control of the WhiteHatt Internet Television system and display of user-targeted content.

### DETAILED DESCRIPTION

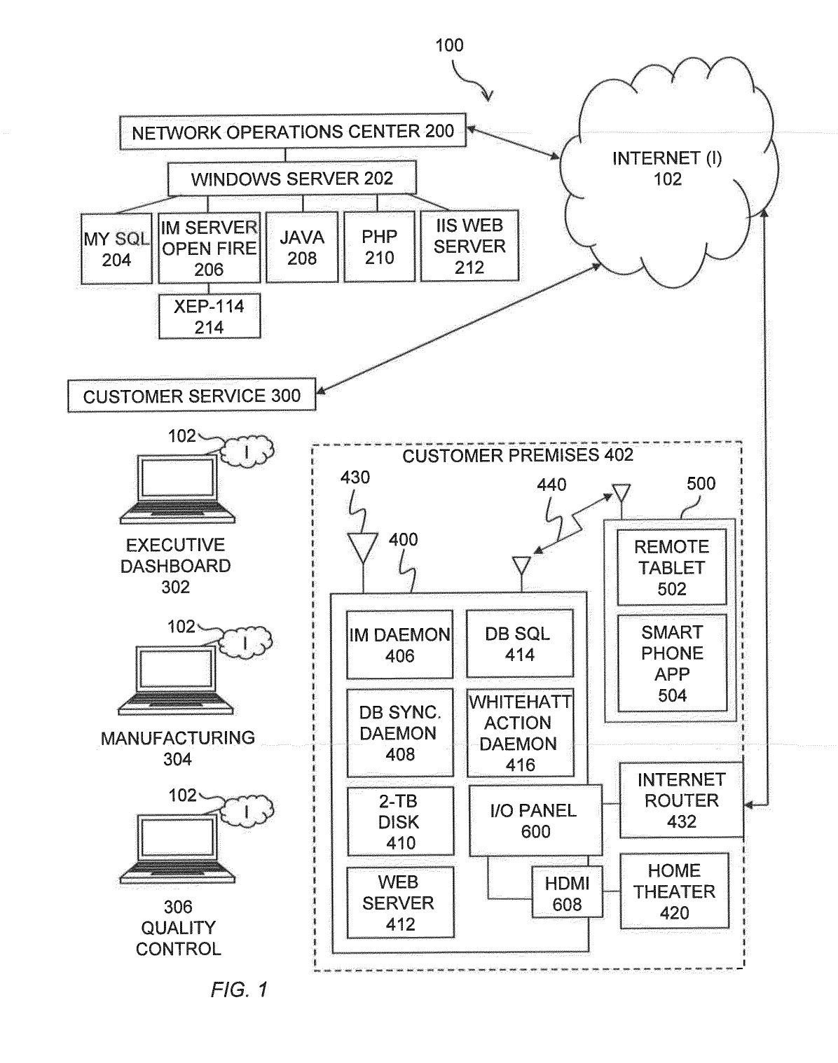

Referring initially to FIG. 1, the overall architecture of the WhiteHatt Internet TV system (WhiteHatt), generally designated 100, of the present invention is depicted. Each of the associated systems of WhiteHatt 100, including the Network Operations Center (NOC) 200, Customer Service 300, the Executive Dashboard 302, Manufacturing 304, Quality Control 306, and the Smart Top Box™ (STB) 400 in the customer premises 402 are connected to the Internet 102, the main communication system among the various other components of the entire WhiteHatt 100 system.

WhiteHatt 100 is primarily designed for residential purposes, and comprises three main components: (1) STB 400; (2) Operating system and associated proprietary WhiteHatt software; and (3) Remote Control system 500. Each part of the WhiteHatt 100 is programmed from the factory and is described with specifications below.

Through Internet 102, STB 400 communicates from the customer premises on a system level to the NOC 200, and Customer Service 300. NOC 200 is designed for use on Windows Server 202, providing such services as MySQL (Structured Query Language) 204, Instant Messenger (IM) Server via Open Fire 206, JAVA 208, PHP 210, and IIS (Internet Information Services) Web Server 212. The foregoing is a non-exhaustive list of the services employed to allow users to seamlessly access web services through their STB 400 and system administrators and system engineers to ensure proper system operation. Open Fire 206, a powerful instant messaging and chat server, further implements XMPP (Extensible Messaging and Presence Protocol) for use with XEP-114 214 standard, It is to be appreciated by those skilled in the art that the system architecture is customizable and can change with evolving code standards and protocols, thus the above is not intended to be limiting.

Communication between the various components of the WhiteHatt 100 architecture is conducted via a standard webpage interface. From customer premises 402, customers navigate the system as they would an ordinary website on the World Wide Web. Likewise, WhiteHatt administrative and executive personnel maintain a higher level of access and capabilities within the system, utilizing the same webpage interface to manipulate functions within customer service 300, executive dashboard 302, manufacturing 304, and quality control 306. Each department has an associated level of access appropriately restricted to the required functions of that department.

Quality Control (Q/C) 306 is implemented to ensure each STB 400 unit has passed a rigorous quality test prior to delivery to customers. A Quality Assurance engineer presides over the process to ensure each STB 400 delivered will not only work in the market, but also provide customers with a high quality product and viewing experience. Q/C 306 receives each STB 400 from Manufacturing 304 and subjects it to various quality tests. If the particular unit passes, then it is sent for delivery. If not, the unit is sent back for repair or rebuild.

Manufacturing 304 is in constant communication with Q/C 306 throughout the production process. Each department is connected to the Internet and progress and status can be monitored by the Executive Dashboard 302.

A typical sequence might include the process by which the bottom half of the STB 400 is assembled and connected to a monitor, in order to ensure it functions as advertised, at which point it might be moved to a diagnostics rack for several days to accommodate pre-delivery testing, receiving customer downloads for personalization with their specific user data, and then final assembly and packaging for shipment.

Executive dashboard 302 provides WhiteHatt executive level information and control over services. Executive dashboard is not a commercial data distribution tool for the STB 400 and customers do not have access to those functions. Executive Dashboard 302 provides WhiteHatt administrators details about broken services, projects in work, and products still in manufacturing 304, Q/C 306, among other information required for seamless operation.

The Network Operations Center 200, located at WhiteHatt Technologies, Inc., obtains user-targeted advertising and other contents available to customers from the Internet from various websites, vendors, and other commercial entities through Internet 102. The aforementioned content may be obtained through specific licensing agreements and contracts with digital content providers, such as television stations and particular Internet media providers, for further distribution and viewing through STB 400 in customer premises 402. This information is broadcast to the WhiteHatt customer base and is filtered upon arrival at the STB 400 for individual users.

On a larger scale, World Wide Web contents are not specifically delivered through NOC 200 and WhiteHatt 100. Rather, WhiteHatt 100 is a “content consolidator” and provides an Internet content delivery method, facilitating the user's access to online content through STB 400. No licensing is required for content of which NOC 200 never has possession. For example, should a user access www.abc.com to watch an archived episode of her favorite television show, she is accessing www.abc.com's servers, not the WhiteHatt 100 infrastructure, thus no specific license is required. Further, as discussed in more detail below, links regarding user-targeted advertising are displayed on remote tablet 502 following delivery and filtering by STB 400. When a user clicks on these advertising links provided by NOC 200 to customer premises 402, remote tablet 502 calls for a URL that is then accessed by STB 400 and displayed for the user on home theater 420. The content then requested is provided from that URL directly, not by NOC 200.

Customer information and viewing preferences are input during the WhiteHatt online ordering process, and is subsequently programmed to individual STBs 400 prior to shipment to customers. This information resides within the STB 400 and is firewalled from the rest of the Internet.

Because personal information is isolated within customer premises 402, the NOC never has usable unencrypted records of individual users' viewing habits and preferences. NOC 200 does maintain copies of the serial number a particular customer's STB 400, in addition to a backup of the original customer information referenced to the serial number of the individual STB 400, and stored in an encrypted format.

WhiteHatt Technologies, Inc. retains minimal information regarding their customer base: only those records necessary for purposes of customer service, maintenance, and backup of STB 400 information in the event of system failure. For instance, in the case of a broken or warrantied STB 400, NOC 200 will retain only the information necessary to allow customers to the ship STB 400 back to the factory for replacement or repair. Since the data is localized within STB 400, a new STB 400 is synchronized and shipped back to the customer.

Alternatively, under certain circumstances, WhiteHatt Technologies, Inc. may ship a new STB 400 to the customer who may then synchronize personal data to the new STB 400 prior to shipping the broken STB 400 back to the factory. Further, in extenuating circumstances, this data may be synchronized via an encrypted Internet link with the NOC 200. This option, while technically feasible within the system of the present invention, is not preferred as it runs contrary to the priority of keeping user data from being transmitted.

STB 400 within Customer Premises 402 stands for the main embodiment in the present invention of the WhiteHatt Internet TV system 100. STB 400, as shown in later Figures, is a single unit that combines an integrated combination DVD (digital video disc) and Blu-Ray player/recorder, inputs for USB, coaxial cable, HD video, HD audio, Ethernet, HDMI port, and associated outputs for home theater. In a preferred embodiment, STB 400 utilizes a single HDMI line out 608 to easily connect to home theater 420. It is to be appreciated by those skilled in the art, that HDMI includes audio and video signals, and similarly home theater 420 refers to both the aural and visual displays of media provided by WhiteHatt 100 and STB 400 on input/output (I/O) panel 600 (described in FIG. 3). An embodiment of the present invention may include an STB 400 with provisions for other similar outputs such a three-color component video output, multi-channel audio output, or similar. A single HDMI output 608 is envisioned for simplicity of manufacture and ease of use, but should not be considered as limiting.

Remote system 500 includes remote tablet 502 and smartphone app 504, and is incorporated for simplified operation within the customer premises 402. The remote tablet 502 communicates via an 802.11 standard Wi-Fi connection 440 to the STB 400 through the network stack. In this context, the “network stack” refers to a layered set of software protocols, which work together to provide a desired set of network functions. Each intermediate protocol layer uses the layer below it to provide a service to the layer above, and ultimately connects the hardware layer, including the physical Internet connection (RJ-45) to the webserver within the STB 400 firmware and displaying contents for the user. STB 400 is designed to run Microsoft's IIS within STB 400. Microsoft IIS (MS IIS) is a web server application and set of feature extension modules created for use with Microsoft Windows. MS IIS is designed for use with a single remote tablet as opposed to multiple net users. While MS IIS is presently the preferred software, this should not be viewed by those skilled in the art as a limiting characteristic of the present invention.

WhiteHatt 100 adopts a custom operating system designed specifically for the STB 400 with a custom Windows-based user interface (UI). The UI is equipped with Microsoft “Windows Embedded Standard 7C (WES7C)” and contains provisions for standard web services when connected to the home network in customer premises 402. Individual users may create their own personal profiles or accounts partitioned within the two-TB hard drive 410 contained within STB 400 for expanded security. These individual accounts further provide space within hard drive 410 for the storage of media saved from the four ATSC digital tuners, or the other inputs to the STB 400. The WhiteHatt OS provides an administrator profile, which enables individual users with appropriate access permissions to enable and maintain parental controls and privacy settings for each account.

The custom Windows interface provides easy access to the various features of the WhiteHatt proprietary media center software through remote control system 500, or more specifically, tablet 502 and smartphone app 504. Each of these remote controls provides the user with complete access to their own accounts within STB 400. The OS further contains proprietary software for management of the remote control interfaces.

FIG. 1 further shows the various parts of WhiteHatt OS. WhiteHatt OS provides many features such as a proprietary Parental Control Application with content logging, multiple accounts for individual users, and component controls for the devices attached to STB 400. The OS further comprises multiple subsystems including an IM Daemon 406, DB synchronization Daemon 408, storage media, such as a single two-TB Disk 410, Web Server 412, DB (database) SQL (Sequence Query Language) 414, WhiteHatt Action Daemon 416, and I/O panel 600, for use with a home theater system 420.

IM (Instant Messenger) Daemon 406 is a computer program, resident within the OS on the STB 400, that runs as a background process, rather than being under direct control of an interactive user. No user input is required. The IM Daemon 406 acts as a bi-directional messenger allowing transmission of information to and from the NOC 200. This is a persistent and encrypted connection between the STB 400 and the NOC 200, required to send and receive commands, and operates as the signaling channel by which WhiteHatt administrators command individual STBs 400 to update software, modify system protocols, or other system level operations. All data transmissions between the NOC 200 and STB 400 flow via the IM channel.

The Database (DB) Synchronized Daemon 408 is another background process that requires no user input. The DB synchronization daemon 408 selects the database entry from the URL lookup table within the NOC 200 and transfers it to the local database, which then mirrors the NOC 200 database.

Under the WhiteHatt OS operating scheme, customers are not able to access every URL on the Internet, only those URLs within the WhiteHatt database or those provided through advertising or other content pushed to individual remote tablet 502. The DB synchronization daemon 408 is required to crawl databases within STB 400 and ensure they mirror those at the NOC 200, in order to avoid bootlegged or stolen apps, desktop uses, copyright violations, or other activity in violation of WhiteHatt contracts with licensed vendors or copyright law. Great care must be taken to prevent installation of unlicensed content or unauthorized applications onto the system. This includes bit torrents and other pirated material. However, WhiteHatt customers can add URLs to the database through a request to the WhiteHatt administrators, who determine whether the content is legal and licensed.

Web server 212 refers to the software, or more particularly, the application that operates in conjunction with the DB synchronization daemon 408, IM daemon 406, DB SQL 414, and the WhiteHatt action daemon 416 and assists the delivery of Internet content to STB 400 for display.

DB SQL 414 is a portion of MySQL (referenced above) installed locally, within STB 400, as a relational database management system (RDBMS) that runs as a server providing multi-user access to a number of databases within STB 400 and to those with NOC 200 when required by WhiteHatt 100.

WhiteHatt Action Daemon 416 is a further background application that monitors changes within the system and reacts to user commands, most often from remote tablet 502, and commands reconfiguration of STB 400 resources based on system requirements. Action daemon 416 polls systems resources and databases in an effort to determine what system actions must be taken. These actions range from activating the Blu-ray drive upon user command, for instance, to switching an active viewing channel, or recalling an television episode stored by the DVR.

The OS in the present invention contains proprietary software for management of the remote control interfaces of remote control system 500, and on-screen search functions to search licensed online content. Users can program the STB 400 through remote system 500 to automatically launch searches for online movies, network television programs, and similar legal and licensed content. All broadcast content is recordable via a DVR integrated into STB 400. Also, select rental or purchase content from a licensed vendor may be recordable via the DVR. Users can search contents using the LCD screen 506 (shown in FIG. 5) on the WhiteHatt remote tablet 502. Further, once content is loaded to the STB 400, that content or media is accessible irrespective of an Internet connection.

WhiteHatt OS allows users to access their favorite media via a single interface through STB 400. WhiteHatt OS contains an integrated Netflix player, and streams both free contents and pay-per-view contents. OS also has integrated applications, such as Skype, Facebook, Pandora, and Internet radio capabilities. For example, users can select the radio icon provided on the WhiteHatt OS interface, enter the name of a favorite artist or group and select play. Other sites, such as Pandora.com, can also be accessed via the Internet to supply licensed contents through STB 400 directly to users. The OS of the present invention supports integrated HD audio and video, and also allows high definition streaming of such online Internet programming as Hulu.com, Fancast.com, YouTube.com, etc. WhiteHatt OS also has integrated the virtual surround sound controls to access and control the surround sound from WhiteHatt remote control system 500.

The OS in the present invention has functions for Internet search, email, social networking, among other online services through home theater 420. Home theater 420 may be as extensive as a big screen HD monitor and full surround sound system or simply a television display with integrated audio. STB 400 has four integrated digital television tuners with play/pause DVR controls, which are reflected on the remote system 500 controls. These multiple tuners allow viewing and recording of up to four programs at once. Signals received through a specially designed ATSC OTA antenna enable STB 400 to receive the four separate signals simultaneously.

Recording is accomplished through the use of DVR, and STB 400 is capable of recording up to full 1080p HD. It is to be appreciated by those skilled in the art, that the number of tuners explained herein and associated DVR capability is not intended to be limiting. The number (four) in the preferred embodiment was selected by reason of receiver capabilities of associated OTA antennae, space available within the processor, and confines of the STB 400. More or fewer tuners may be implemented, given the appropriate antenna, processor capacity, memory, and physical space.

WhiteHatt OS allows VoIP integration, which typically requires a third party VoIP service. When using the VoIP service, STB 400 provides services to display the information on all available displays, including a home theater 420 display, and remote control system 500 displays, may then choose to answer or ignore VoIP calls remotely. WhiteHatt OS also incorporates automatic muting of media while a VoIP call is in progress.

The fully operational, plug-and-play WhiteHatt STB 400 will be shipped directly to customer premises 402, with no need of set up. However, for security purposes, the OS in the present invention has been registered to the WhiteHatt server with security codes, according to security protocols, before shipping. Such security protocols provide users with theft prevention and parental controls with no dedicated user action. WhiteHatt remote tablet 502 is also integrated with this security protocol. Security profiles for both STB 400 and remote tablet 502 are customizable upon receipt of the unit at customer premises 402.

The WhiteHatt OS in the present invention automatically logs errors and sends them to NOC 200 for correction and update in real-time, and has a server update depository for system and software updates. This process is also accomplished by the IM Daemon 406. This information, is then available through NOC 200 to the individuals utilizing the Executive Dashboard 302, or those responsible for the operations of the Manufacturing 304 and Quality Control 306 departments.

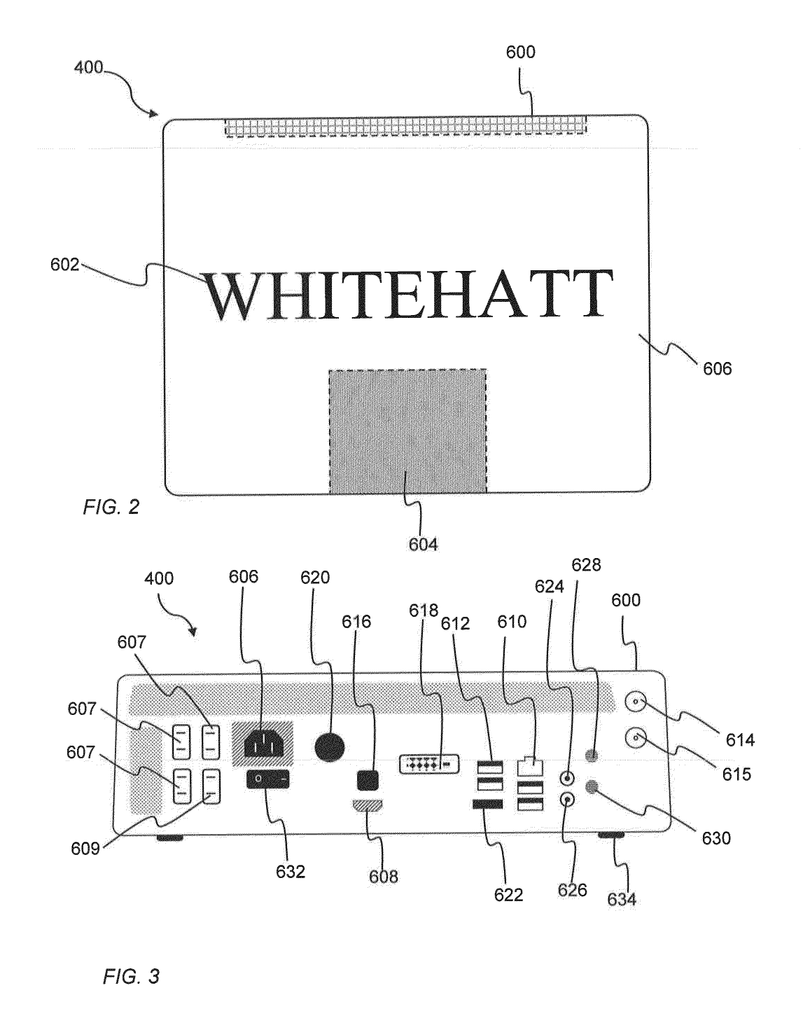

Referring now to FIG. 2, a top view of the WhiteHatt STB 400 of the present invention is shown. STB 400 is formed as a box, similar to a desktop computer, with centralized logo 602 on top, provisions for a DVD/Blu-ray/CD or media slot 604 (shown in phantom) on one side. All wired connections are accessible via a recessed I/O panel 600 (shown in phantom) on the back of STB 400. It should be appreciated by those skilled in the art, that the shape of STB 400 is not intended to be limiting. An embodiment of the STB 400 of the present invention can easily be formed in a different shape. Further, an embodiment of the present invention makes use of multiple media drives similar to slot 604. These slots 604 may be spaced on the front of STB 400, or distributed accordingly.

Referring now to FIG. 3, a perspective view of the recessed panel 600 is shown, along with a bottom view of the WhiteHatt STB 400. STB 400 requires a minimum of three cables for installation: a power receptacle 606, power supplies 607; high speed Internet connection, such as Ethernet or Wi-Fi, and an HDMI 608 output to the home theater 420, making installation in the consumer premises exceedingly simple. Should a wired high-speed Internet connection such as an Ethernet cable utilizing an RJ-45 610 connector not be required, the optional wireless 802.11 Wi-Fi connection 440 is also present, requiring only two physical connections for operation.

Recessed I/O panel 600 provides a variety of electrical and electronic input and output connections for seamless integration into an existing home theater. Even as WhiteHatt is intended as a CATV “alternative,” the connections provided on the STB 400 and provisions within the OS, allow for connection of CATV, or SATV cable in addition to the WhiteHatt media center, Internet TV, and other capabilities through multiple coaxial connections 608.

In an preferred embodiment, recessed I/O panel 600 comprises HDMI port 608; RJ-45 input 610 (Ethernet); four USB inputs 612 intended for such uses as PC gaming, which works with Bluetooth™ game controllers; OTA antenna input 614 and coaxial input 615 for local CATV, SATV, or ATSC programming; HD Audio input 616 (such as optical or digital audio, or other connections known in the art); one HD Video port 618 (such as VGA, DVI, or other connections known in the art); remote tracker button 620; external serial SATA (Serial Advance Technology Attachment) 622; RCA stereo audio jacks 624, 626; external Wi-Fi antennae inputs 628, 630; and power switch 632 for initiation of STB 400 from a power off state, or a shutdown and reset as required. It is to be appreciated by those skilled in the art that the selection of input and outputs to and from STB 400 and their orientation on I/O panel 600 should not be viewed as limiting.

In an embodiment, power receptacle 606 provides power to STB 400 through an uninterruptible power supply (UPS) (not shown) within STB 400. The UPS functions as a standard UPS known in the art, and provides voltage regulation and surge protection to all connected components to STB 400 through various inputs and power supplies 607 and 609. It is important to note that total surge protection is not provided for systems requiring additional power from a separate location, but only power surges through connections on STB 400.

The UPS further provides uninterrupted power to certain connected components during power fluctuations. Should STB 400 experience a power flicker, brown out, or complete power loss during recording via DVR, the UPS will provide a power reserve to critical system operations, including Internet router 430, and OTA antenna 432, if individually attached to power supplies 607. In a preferred embodiment, the UPS provides a power reserve for approximately five to seven minutes, but may be longer depending on the UPS design. The power reserve is available until power to the customer premises 402 is reactivated or until the UPS power reserve is exhausted. Provided the HD signal to the OTA antenna or Internet connection to customer premises 402 remains active during the power loss, the DVR will continue recording. If power to customer premises 402 is interrupted for longer than the UPS has capacity to power the system, WhiteHatt OS will command a shutdown and audible and visual notice will be provided to the remote tablet 502 indicating system shutdown. This not only preserves the media being recorded on the DVR, but also avoids the inevitable and time consuming reboot process most set top boxes must execute following a power loss or hard-boot.

In an embodiment, a plurality of power supplies 607 and 609 are formed into STB 400, providing power to connected components. Power supplies 607 and 609 provide slightly different functions. In a preferred embodiment, the power supply for Internet router 430 and OTA antenna 432 is provided through power supplies 607. Full UPS power reserve and surge protection is supplied through power supplies 607 in order to preserve recorded media as discussed above. The power requirements for such components are within the capabilities of a typical UPS as formed into STB 400. In contrast, power supply 609 only provides surge protection, not a UPS power backup. In a preferred embodiment, such a power supply 609 is intended for use with a television monitor or display, due to the significantly larger power requirements of a standard monitor. This arrangement further provides a level of convenience, as when STB 400 is powered on, it begins supplying power to all connected components, alleviating the need for the user to power-on components individually. It is to be appreciated by those skilled in the art that the number of power supplies illustrated in this Figure (four), should not be considered as limiting. Different designs and mother board configurations may offer more or fewer power supplies 607, 609.

In an embodiment, I/O panel's 600 recessed construction allows easy and expeditious installation of STB 400 on a vertical wall via wall anchors. The bottom of STB 400 is formed with a plurality adjustable feet 634 that may be removed to allow such a vertical installation. The feet 634 on STB 400 are padded and intended for use in a horizontal installation, and prevent slippage.

Remote tracker button 620 is present to allow the user to locate a missing tablet 502. When remote tracker button 620 is depressed, an audible tone or other suitable alert is emitted from tablet 502, identifying its location to the user.

USB inputs 612 are included in this embodiment for expansion for Internet gaming controls, or connection of other peripheral accessories. Likewise, SATA port 622 is provided for connection to other expansion accessories, such as a backup hard drive.

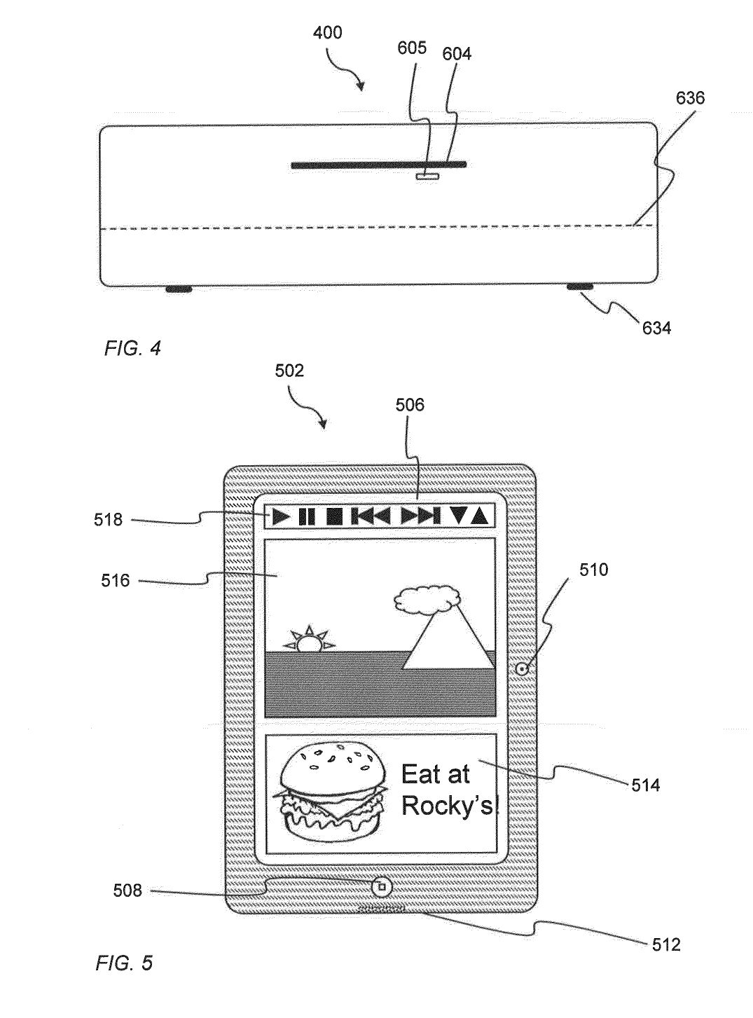

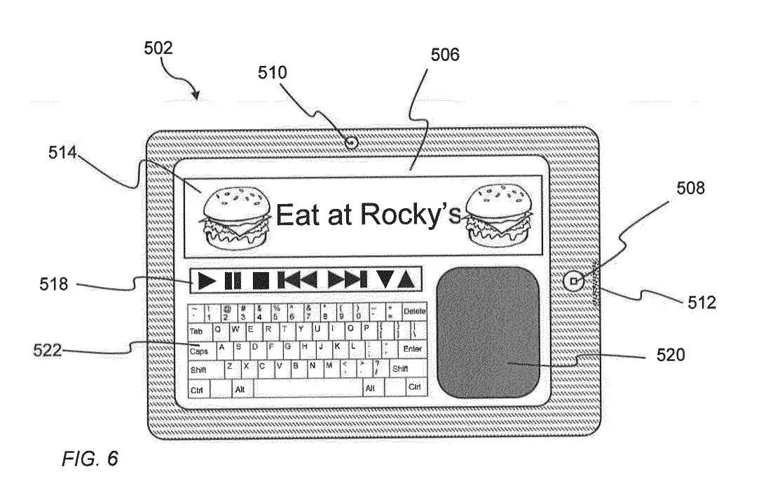

Referring to FIG. 4, a front view of the STB 400 of the present invention is shown. In an embodiment, STB 400 is equipped with Bluetooth™ and Wi-Fi antennae. In an embodiment, these antennae are intended to wrap around the horizontal periphery of STB 400, through channel 636 (shown in a dashed line). An embodiment of the present invention may further include STB 400 with a plurality of channels 634 to prevent interference between associated signals and power requirements. Another embodiment of the STB 400 of the present invention makes use of an external Wi-Fi antenna and the external Wi-Fi antennae inputs 628, 630 as opposed to the internally embedded systems. The STB 400 of the present invention may also be formed with an internal OTA antenna. Depending on the power output and location of the system, externally mounted antennae may desirable for reduced interference and improved reception.

The Integrated Bluetooth™ antenna is compatible with many peripheral accessories, such as a mouse and keyboard, audio headset for gaming, or combination earpiece-microphone for utilizing VoIP functions. This connection provides the user with options for multiple possibilities for system control.

STB 400 further features a Blu-ray/DVD combo drive with media slot 604 on the face of the STB 400. In an embodiment, the combo drive is an adapted read and write Blu-ray/DVD/CD or other optical media. The internal hard drive, or hard drives (not shown), resident within STB 400, are designed for use with the WhiteHatt media center, which allows for user playback of media stored on the hard drives. Slot 604 is further equipped with ejector button 605 for removal of disks from slot 604. It is to be appreciated by those skilled in the art that many different options are possible with respect to the number of media drives and hard drives, thus the single media slot 604 and hard drives should not be viewed as a limiting characteristic.

Another main component included as part of Customer Premises 402 in the WhiteHatt Internet Television system, is a unique remote tablet, generally designated 502. Referring to FIG. 5, remote tablet 502, of the WhiteHatt Internet Television system of the present invention is shown. Remote tablet 502, in a broad sense, allows the user to manipulate every aspect of the WhiteHatt 100 from a remote location within reception of the 802.11 Wi-Fi connections 440. Remote tablet 502 includes touchscreen LCD 506, home key 508, and camera 510, as shown.

Tablet 502 is the primary remote control in remote system 500. In a preferred embodiment, tablet 502 communicates with STB 400 via a Wi-Fi connection 440. This enables the user to be mobile and still retain full control of the WhiteHatt 100 system. While a mouse and keyboard may be employed to control WhiteHatt OS, remote tablet 502 is incorporated in effort to eliminate the need for a separate keyboard and mouse when connected to personal computers, WhiteHatt STB 400, or other Bluetooth™ enabled Internet TV systems. Remote tablet 502 thus brings the keyboard and mouse, TV, DVD, Blu-ray, and Media Center controls together into a single, hand held unit. Remote tablet 502 adopted in the present invention is equipped with an LCD touchscreen 504 in part to prevent user eyestrain, but also to very quickly allow the user to manipulate the controls, providing the user with a display of commands to STB 400, and delivering user-directed content from the Internet.

The focus of FIG. 5 and of the remote system 500 is the embedded advertisement function. When a WhiteHatt STB 400 is shipped to customer premises 402, information identifying the user(s) is present within the OS. Because privacy is of paramount concern in the days of social networking and the globally connected Internet environment, personal information is protected by privacy protocols, including a firewall, and rarely leaves the STB 400. There are only a few rare exceptions when personal information data is transmitted from STB 400, such as to facilitate maintenance and backup, and in those cases, only the essential data is transmitted and only in an encrypted format) the STB 400, making personal information inaccessible by an external entity. In an embodiment, the information is further customizable once installed in customer premises 402, and further editable for the creation and modification of additional user profiles or accounts.

The personal information contained within STB 400, is utilized in a user-interface assessment program contained within the WhiteHatt OS or from third party suppliers of directed advertisements. The WhiteHatt OS through its logging of content viewing history, assesses the channels, websites, movies, or other content the user accessed has accessed in the past. Through these assessments, WhiteHatt OS filters advertisements from the broader Internet and displays and arranges specific advertisements 514 appropriate to and targeted at the user via LCD touchscreen 506. User-targeted content such as advertisements 514 will primarily include content from specifically licensed vendors and paid advertisement through WhiteHatt Technologies, Inc.

In an embodiment, user-targeted content 514 may be an advertisement, as shown, or banners for commercial offers, notices of current event, news, or even a scrolling stock ticker. All user-targeted content 514 is filtered at the STB 400 and transmitted to remote tablet 502 predicated on the particular user profile. Additionally, advertisements 514 can appear with other media 516 being viewed with the remote tablet 502.

For example, if through analysis of browsing history, the OS determines that the present user is a classical music enthusiast, tablet 502 would select and display on LCD 504 appropriate advertisements or promotions related to the classical music, or other viewing history.

By virtue of the fact that the filtering operations occur locally, within STB 400 and remote tablet 502 by WhiteHatt OS, no personal information stored within STB 400 leaves the system for use in filtering content and advertisement displayed to users. Indeed, there are only a few rare exceptions when personal information data is transmitted from STB 400, such as to facilitate maintenance and backup, and in those cases, only the essential data is transmitted and only in an encrypted format) the STB 400, making personal information inaccessible by an external entity. Advertisements 514 are collected from the Internet 102, and only the information particular WhiteHatt users want to see is displayed.

The customer may manipulate the controls 518 adjusting channel, volume, and similar functions, while viewing selected media 516. Media 516 may be a photo taken with integrated camera 508 or even a video call via an Internet application or VoIP, among many other options. The foregoing examples are not intended to be limiting to the present invention.

Remote tablet 502 further has an integrated, rechargeable and user-replaceable battery to power the tablet. The battery is designed for use with charging port 512 and accompanying charging unit (not shown) that can be plugged into any standard residential power source.

Referring now to FIG. 6, remote tablet 502 is depicted with touchscreen LCD 506 programmed as a track pad 520 and keyboard 522. In an embodiment, remote tablet 502 is equipped with an accelerometer (not shown), enabling the system to orient itself to a portrait mode (as in FIG. 5) or landscape mode as shown, and allow for more effective use of screen space when being used as a keyboard. An embodiment of the remote tablet 502 allows the user to move controls on the screen and set user-specific preferences for keyboard 522, trackpad 520, and controls 518 layout.

Remote system 500 is further designed to operate under the control of smartphone applications 504 (apps), for iPhone and Android OS model smartphones, but may be expanded as technology matures. In a preferred embodiment, the smartphone apps 504 are designed to operate under the same Wi-Fi protocols as tablet 502 and provide identical functionality, through a smaller, yet equally functional interface on the screen of a user's smartphone.

While there have been shown what are presently considered to be preferred embodiments of the present invention, it will be apparent to those skilled in the art that various changes and modifications can be made herein without departing from the scope and spirit of the invention.

We claim:

1. An Internet television system, comprising:
a set top box within a customer premises having a means for connecting a plurality of media inputs to a home theater system within the customer premises, a means for Internet communication with a network operations center, and means for wireless communication with a remote control system;
a network operations center, having a means for Internet communication with the set top box within the customer premises for sending media content and advertising to the set top box for display to the customer; and
a remote control system having a means for wireless communication with and control of the set top box functions, a means for adaptively filtering content received from the network operations center based on customer viewing habits, and a means for displaying user-targeted media and content to the user.

2. The Internet television system of claim 1, wherein the set top box has an uninterruptible power supply means for providing voltage regulation, surge protection, and temporary power for critical system operations following power loss.

3. The Internet television system of claim 2, wherein the set top box has an uninterruptible power supply means for providing voltage regulation, surge protection, and temporary power for critical system operations following power loss to external Internet equipment

4. The Internet television system of claim 2, wherein the set top box has an uninterruptible power supply means for providing voltage regulation, surge protection, and temporary power for critical system operations following power loss to external OTA television equipment.

5. The Internet television system, of claim 1, wherein the set top box has at least one optical media drive providing capabilities to read and write optical media.

6. The Internet television system, of claim 1, wherein the set top box has at least one input means for receiving high definition video signals from wireline, satellite, and aerial broadcast systems.

7. The Internet television system, of claim 1, wherein the set top box has at least one input means for receiving high definition audio signals from wireline, satellite, and aerial broadcast systems.

8. The Internet television system, of claim 1, wherein the set top box has at least one output means for sending high definition audio and video signals to a home theater system for audio and visual display.

9. The Internet television system, of claim 1, wherein the set top box has recessed panel to accommodate various input means and output means.

10. The Internet television system, of claim 1, wherein the set top box has a plurality of digital television tuners capable of receiving an equal plurality of signals simultaneously.

11. The Internet television system, of claim 1, wherein the set top box has at least one digital video recording means capable of recording content received from the individual digital television tuners simultaneously.

12. The Internet television system, of claim 1, wherein the remote control has a remote tablet and remote software application.

13. The remote control system of claim 12, wherein the remote tablet has a user-customizable touchscreen liquid crystal display for control of the set top box operation, and display of the adaptively filtered user-targeted media.

14. The remote control system of claim 12, wherein the remote tablet has a user-customizable touchscreen liquid crystal display for control of the set top box operation, and display of the adaptively filtered user-targeted media wherein the adaptive filter is located solely within the set top box.

15. The remote control system of claim 10, wherein the remote tablet has user-specific profiles capable of displaying multiple forms of media, advertisements, while allowing complete control of set top box operation.

16. The remote control system of claim 15, wherein the user-specific profiles include a means for adjusting levels of user access, content logging, and parental controls.

17. An internet and over the air television system, comprising:
a network operations center in communication with a global computer network;
a plurality of smart top boxes, each said smart top box in communication with said global computer network;
a means for disseminating internet content from said network operations center to each said smart top box, said internet content comprising media and advertising;
a means for filtering said internet content within each said smart top box to display a portion of said internet content unique to said smart top box.

18. The internet and over the air television system of claim 17, wherein each said smart top box further comprises:
a means for receiving broadband content from one or more broadband content providers; and
a means for filtering said broadband content within each said smart top box to display a portion of said broadband content unique to said smart top box.

19. The internet and over the air television system of claim 17, wherein each said smart top box further comprises a means to record internet content.

20. The internet and over the air television system of claim 17, wherein said means for filtering said internet content further comprises;
a means for compiling user specific preference data for each said smart top box;
a means for comparing said internet content against said user specific preference data; and
a means for displaying only said internet content in accordance with said user specific preference data.
